(19) United States
(12) Patent Application Publication
(10) Pub. No.: US 2002/0084292 A1
(43) Pub. Date: Jul. 4, 2002

(54) Container for dispensing a small amount of the contents

(76) Inventor: Antony Chen, Taichung (TW)

Correspondence Address: Cooper & Dunham LLP, 1185 Avenue of the Americas, New York, NY, 10036, US

(21) Appl. No.: 09/751,020

(22) Filed: Dec. 28, 2000

(51) Int. Cl. G01F 11/26; B67D 5/64

(52) U.S. Cl. 222/456; 222/162

(57) ABSTRACT

A container has a hollow body, a first passage, a U-shaped second passage and an outlet. The first passage is defined in the top of the body. The second passage is also defined in the top of the body and communicates with the first passage through a third passage. The outlet is defined in the top of the body and communicates with the second passage. With such a container, a small amount of the contents can be dispensed from the container through the passages when the user turns the container upside down repeatedly. In addition, the container with the passages can be formed by a blowing process with a desired mold. It is easy to manufacture and form the container. The cost of manufacturing the container with a dispensing effect is decreased.

### BACKGROUND OF THE INVENTION

1. Field of the Invention

The present invention relates to a container, and more particularly to a container that can dispense a small amount of the contents from the container.

2. Description of Related Art

Substances like sugars, beans, coffees, powders, pet food and washing powders are always kept in a container. When a person wants to use a small amount of the substance in the container, he or she often slightly tilts the container to an inclined position to pour a small quantity of the contents out of the container. However, the quantity of the substance dispersed from the container is not controllable and is usually more than what is needed because the opening in the container is much larger than a single particle. In particular, a child cannot dispense the contents of the conventional container very well, and an excess amount is easily poured out.

With reference to FIGS. 9 and 10, a conventional dispenser (60) in accordance with the prior art is provided to solve the problem of the conventional container. The dispenser (60) is attached to a container (50) and comprises a cap (62), an attachment member (64) and a top board (66). The cap (62) has a first hole (622) and a first tubular member (624). The attachment member (64) is screwed onto the container (50). The top board (66) is attached to the attachment member (64) and has a second tubular member (662) and a C-shaped skirt (664). The first tubular member (624) extends into the second tubular member (662) with a first space (67) defined between the top board (66) and the first tubular member (624). A gap (672) is defined between the second tubular member (662) and the cap (62). An outlet (666) is defined in the top board (66) and communicates with a second space (68) enclosed by the second tubular member (662), the C-shaped skirt (664) and the inner periphery of the attachment member (64).

When a user wants to dispense some of the contents in the container (50), he or she turns the container (50) with the dispenser (60) upside down. Some of the contents will fill the first space (67). When the user turns the container (50) right side up, the contents facing the gap (672) will drop into the second space (68). Consequently, a small amount of the contents will be poured from the outlet (666) when the user turns the container (50) upside down again.

However, although the conventional dispenser (60) can release a small amount of the contents from the container (50), there are so many elements to the conventional dispenser (60) that the conventional dispenser (60) is difficult to manufacture and assemble. The conventional dispenser (60) is expensive to manufacture.

To overcome the shortcomings, the present invention tends to provide a container to mitigate or obviate the aforementioned problems.

### SUMMARY OF THE INVENTION

The main objective of the invention is to provide a container that can dispense a small amount of the contents and easily be manufactured. The container has a hollow body, a first passage, a U-shaped second passage and an outlet. The first passage is defined in the top of the body. The second passage is also defined in the top of the body and communicates with the first passage through a third passage. The outlet is defined in the top of the body and communicates with the second passage. Consequently, a small amount of the contents can be poured out of the container through the passages. In addition, because the container with the passages is a single piece, it is easy to manufacture and form the container. The cost to manufacture the dispensing container is decreased.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a container in accordance with the present invention;

FIG. 2 is a cross sectional side plan view of the container in FIG. 1;

FIG. 3 is a top plan view of the container in FIG. 1;

FIG. 4 is an operational side plan view in partial section of the container in FIG. 1 showing some of the contents filling the first passage, which will face the second passage through the third passage when the container is turned right side up;

FIG. 5 is an operational side plan view in partial section of the container in FIG. 4 showing that the small amount of the contents that faced the second passage droped into the second passage when the container was turned right side up;

FIG. 6 is an operational side plan view in partial section of the container in FIG. 5 showing that the small amount of the contents received in the second passage drops from the outlet when the container is turned upside down a second time;

FIG. 7 is a cross sectional side plan view of a second embodiment of the container in accordance with the present invention;

FIG. 8 is a cross sectional side plan view of a third embodiment of the container in accordance with the present invention;

FIG. 9 is a cross sectional side plan view of a conventional dispenser in accordance with the prior art; and

FIG. 10 is an operational cross sectional side plan view of the dispenser in FIG. 9 showing that a small amount of the contents is dispensed from the outlet through the spaces and gap.

### DETAILED DESCRIPTION OF PREFERRED EMBODIMENT

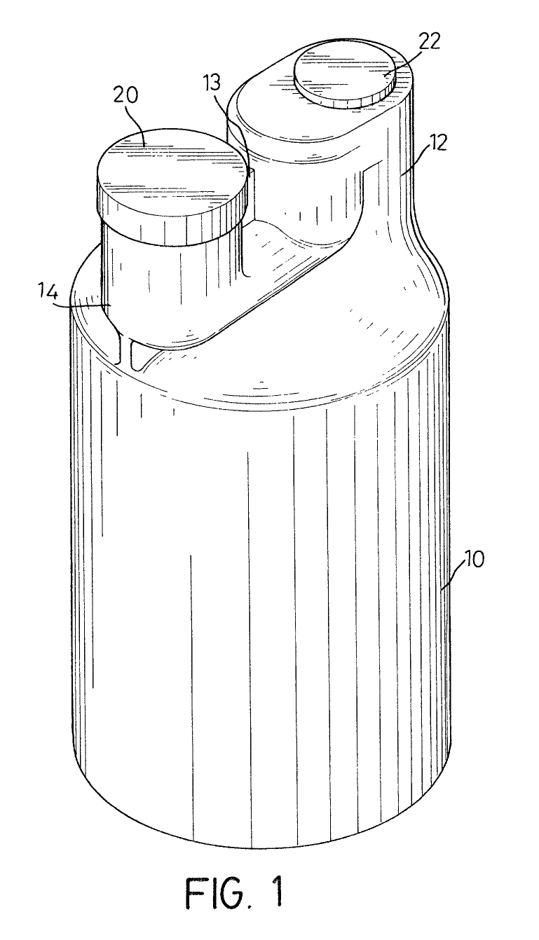

With reference to FIGS. 1 to 3, a container in accordance with the present invention comprises a hollow body (10), a first passage (17), a U-shaped second passage (18) and an outlet (142). The first passage (17) is defined in the top of the body (10) and communicates with the body (10). The second passage (18) is also defined in the top of the body (10) and communicates with the first passage (17) through a third passage (172).

In practice, a first hollow protrusion (12) and a second hollow protrusion (14) are integrally formed on the top of the body (10). The first protrusion (12) communicates with the second protrusion (14). A rib (13) is formed between the first and the second protrusion (12, 14) to enhance the structural strength of the container at the part forming the protrusions (12, 14). A lateral wall (16) is integrally formed between the second protrusion (14) and the body (10) to form the third passage (172). The lateral wall (16) extends into the first protrusion (12). An upward wall (162) is formed upward from the free end of the lateral wall (16) and extends upward into the first protrusion (12). The upward wall (162) is perpendicular to the top of the first protrusion (12) and has a free end separated from the top of the first protrusion (12). Each side of the upward wall (162) is connected with the inner periphery of the first protrusion (12). Consequently, the first passage (17) is defined between the outer periphery of the upward wall (162) and the inner periphery of the first protrusion (17). The third passage (172) is defined between the top of the first protrusion (12) and the free end of the upward wall (162). The second passage (18) is composed of the inner space of the second protrusion (14), the passage communicating between the first and second protrusions (12, 14) and the other inner space of the first protrusion (12) apart from the first passage (17).

The outlet (142) is defined in the top of the second protrusion (14) and communicates with the second passage (18). A dispenser cap (20) is mounted on the second protrusion (14) to close the outlet (142). A fill orifice (122) is defined in the first protrusion (122) and communicates with the first passage (17). A fill plug (22) is mounted on the first protrusion (12) to close the fill orifice (122). Consequently, the user can put the contents into the container through the opened fill orifice (122).

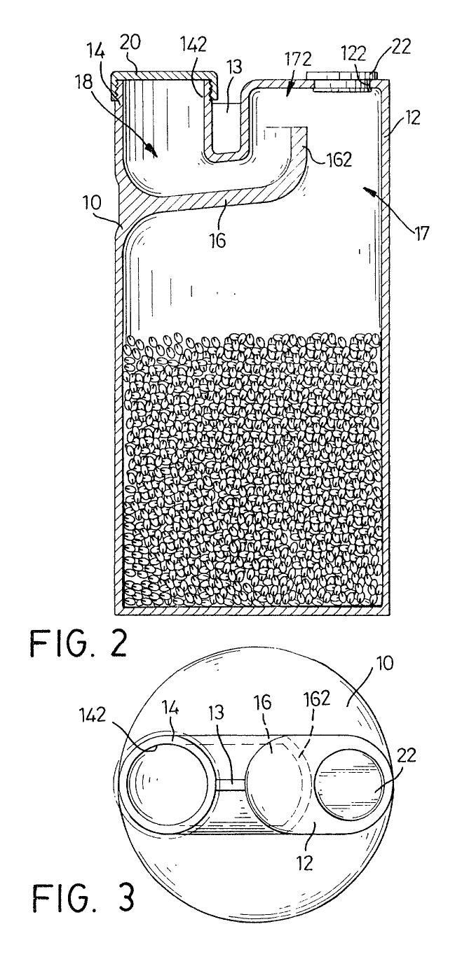

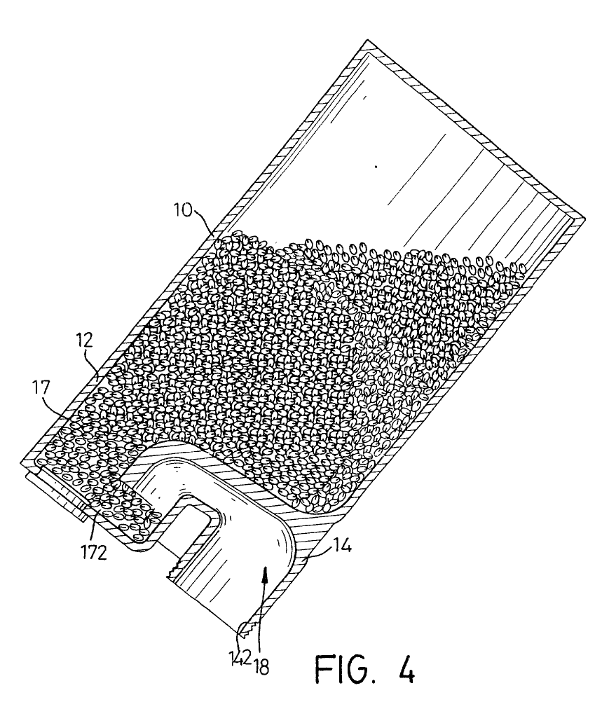

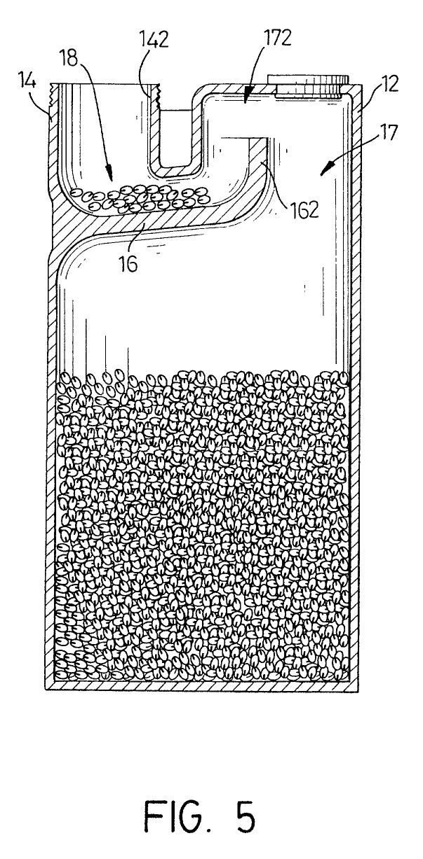

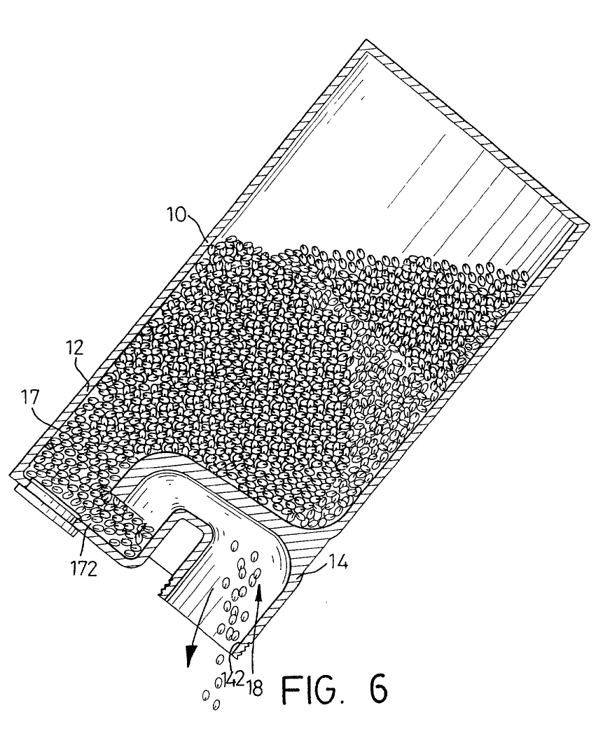

With reference to FIGS. 2 and 4 to 6, when the user wants to dispense some of the contents from the container, he or she removes the dispenser cap (20) first. Next, he or she turns the container upside down. Some of the contents go into the first protrusion (12) to fill the first passage (17), as shown in FIG. 4, and a small amount faces the second passage (18) through the third passage (172). When the user turns the container right side up again, as shown in FIG. 5, the contents facing the second passage (18) will drop into the second passage (18) and the other drops back into the body (10). Furthermore, the small amount of the contents will be poured out from the outlet (142) through the second passage (18) when the user turns the container upside down again as shown in FIG. 6. Accordingly, a small amount of the contents will be dispensed from the container each time that the user turns the container upside down. It is convenient to dispense a desired small amount of the contents from the container. In addition, the container with the passages (17, 172, 18) in accordance with the present invention is a single structure that can be formed by blowing process with a desired mold. The process of manufacturing the container with a dispensing effect is simplified. The cost of manufacturing the container is reduced.

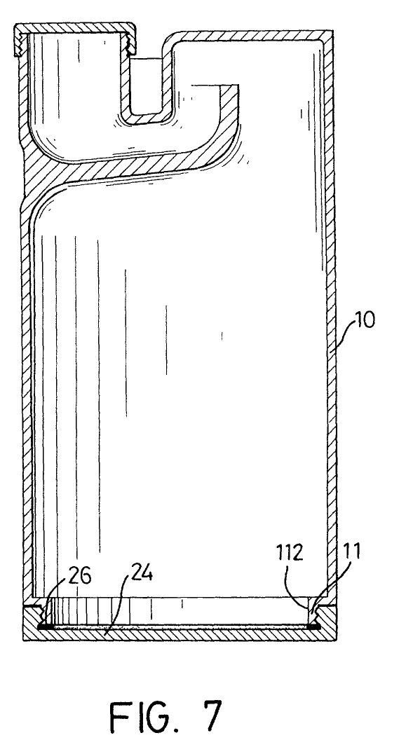

With reference to FIG. 7, an opening (112) is defined in the bottom of the body (10) in the second embodiment. An annular flange (11) is formed on the bottom of the body (10) around the opening (112). A thread is formed on the outer periphery of the flange (11). A bottom cap (24) with an inner thread is screwed onto the flange (11) to close the opening (112). Consequently, the bottom cap (24) can be detached from the flange (11), and a user can put the contents into the container through the opening (112). In addition, a gasket (26) is mounted between the flange (11) and the bottom cap (24) to seal the gap defined between the flange (11) and the cap (24). A sealing effect is achieved.

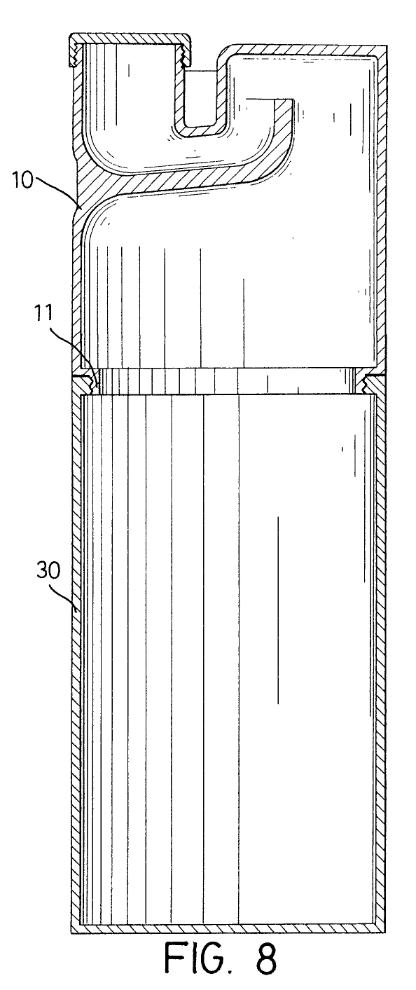

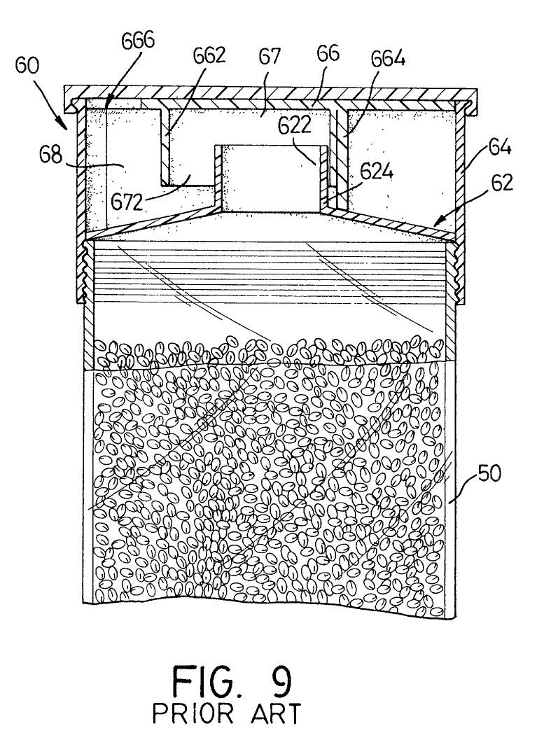

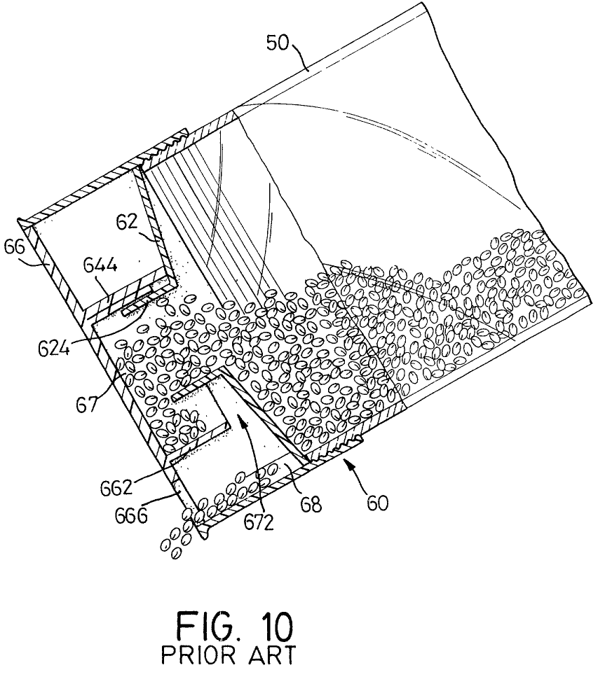

With reference to FIG. 8, in the third embodiment, a second hollow body (30) is screwed onto the flange (11) to enlarge the container. The volume of the container for receiving the contents is adjustable by selecting a second body (30) with a different volume.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A container comprising:
a hollow body;
a first passage defined in a top of the body and communicating with the body;
a U-shaped second passage defined in the top of the body and communicating with the first passage through a third passage; and
an outlet defined in the top of the body and communicating with the second passage.

2. The container as claimed in claim 1, wherein a first hollow protrusion is formed on the top of the body;
a second hollow protrusion is formed on the top of the body and communicates with the first protrusion;
a lateral wall is integrally formed between the second protrusion and the body and extends into the first protrusion to close a communication between the body and the second protrusion; and
an upward wall is formed upward from a free end of the lateral wall and extends upward into the first protrusion,
wherein the upward wall has a free end separated from a top of the first protrusion and each side of the upward wall is connected with an inner periphery of the first protrusion,
whereby the first passage is defined between the outer periphery of the upward wall and the inner periphery of the first protrusion;
the third passage is defined between the top of the first protrusion and the free end of the upward wall; and
the second passage is composed of the inner space of the second protrusion, a passage communicating between the first and second protrusions and the other inner space of the first protrusion apart from the first passage.

3. The container as claimed in claim 2, wherein the outlet is defined in a top of the second protrusion.

4. The container as claimed in claim 3, wherein a dispenser cap is mounted on the second protrusion to close the outlet.

5. The container as claimed in claim 2, wherein a fill orifice is defined in the first protrusion and communicates with the first passage; and
a fill plug is detachably mounted on the first protrusion to close the orifice.

6. The container as claimed in claim 2, wherein the upward wall is perpendicular to the top of the first protrusion.

7. The container as claimed in claim 2, wherein a rib is formed between the first and the second protrusion to enhance the structural strength of the container at the part forming the protrusions.

8. The container as claimed in claim 1, wherein an opening is defined in a bottom of the body;
an annular flange is formed on the bottom of the body and around the opening;
a thread is formed on an outer periphery of the flange; and
a bottom cap with an inner thread is screwed onto the flange to close the opening.

9. The container as claimed in claim 8, wherein a gasket is mounted between the flange and the bottom cap to seal a gap defined between the flange and the bottom cap.

10. The container as claimed in claim 1, wherein an opening is defined in a bottom of the body;
an annular flange is formed on the bottom of the body and around the opening;
a thread is formed on an outer periphery of the flange; and
a second hollow body is screwed onto the flange to enlarge the container.
